(19) United States
(12) Patent Application Publication
(10) Pub. No.: US 2005/0281253 A1
(43) Pub. Date: Dec. 22, 2005

(54) Method for transporting data in telecommunication system, and network element

(75) Inventors: Kari Veijalainen, Vantaa (FI); Basant Dhakal, Espoo (FI); Jukka K. Jaakkola, Oulu (FI); Tamas Major, Dusseldorf (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/132,444

(22) Filed: May 19, 2005

(30) Foreign Application Priority Data
May 19, 2004 (FI) 20045182
Mar. 4, 2005 (FI) 20055104

(51) Int. Cl. H04L 12/50; H04Q 11/00

(52) U.S. Cl. 370/363

(57) ABSTRACT

A data transport method in a telecommunications system is provided. The method comprises creating a traffic channel connection between two network elements in the telecommunications system, allocating data of a number of user entities for transportation over the virtual channel using overbooking, buffering data packets into separate buffers, according to the priority level of the packets, to wait for transport over the traffic channel, and multiplexing the data packets with determined priority levels into the virtual channel according to the priority level of the packets such that whenever higher priority level data packets are available, the higher priority level data packets are multiplexed into the virtual channel before lower priority level data packets. Additionally, formation of user data packets is controlled according to a filling degree of at least one of the buffers.

### FIELD

The invention relates to transporting data between network elements in a telecommunication system.

### BACKGROUND

Due to the high bit rates provided by modern telecommunication systems, several types of data can be transported over a communication network. The transported data can roughly be categorized into delay-sensitive and delay-tolerant data. Delay-sensitive data comprises for example voice, and this kind of data sets quite strict requirements on the delay associated with the data transport over the communication network. Too long delays in voice transmission result in distorted voice quality or even in disconnection. Delay-tolerant data, such as data related to web browsing or e-mail, on the other hand, sets quite loose requirements on the delay associated with the data transport, and even quite long delays, compared to the delays related to the transport of voice, do not necessarily show up to a user in any way.

Within a telecommunication network, very high bit rate data connections are established between the network elements. Data is usually transported over the communication network in data packets, and the size and structure of the data packets are defined by the transport protocols used in the system. The data packets may be transported using either circuit switched or packet switched network. When using a circuit switched network for data transport within the telecommunication network, data from different users may be multiplexed in the same circuit switched connection. This is reasonable if the circuit switched connection between the network elements provides a higher data rate than the connection between a user terminal and the network element the terminal is connected to. Usually this is the case.

In order to satisfy the quality of service related to the delays of the delay-sensitive data, the delay-sensitive data is transported over the communication network using a connection which is capable of transporting the delay-sensitive data over the communication network within the maximum tolerated delay. Within the telecommunication network a number of multiplexed users per a circuit switched connection is never large enough for the capacity of the connection to be exceeded under any circumstances. Thus, the delay requirements of the data can be satisfied. This, however, results in non-efficient use of channel capacity, since for instance with speech connections data is not transported all the time due to pauses in conversation and therefore the channel is not utilized all the time.

### BRIEF DESCRIPTION OF THE INVENTION

An object of the invention is to provide an improved solution for transporting data within a telecommunication system.

According to an aspect of the invention, there is provided a data transport method in a telecommunications system. The method comprises creating a traffic channel connection between two network elements in the telecommunication system, allocating data of a number of user entities for transportation over the traffic channel with each user having a particular, maximum channel capacity demand, the number of user entities being such that a combined maximum channel capacity demand of the user entities exceeds traffic channel data transport capacity, forming data packets belonging to at least two categories, each data packet belonging to the same category being assigned with the same determined priority level, and data packets in different categories having different priority levels, buffering the data packets into separate buffers, according to the priority level of the packets, to wait for transport over the traffic channel, multiplexing the data packets with the determined priority levels into the traffic channel according to the priority level of the packets such that whenever higher priority level data packets are available, the higher priority level data packets are multiplexed into the traffic channel before lower priority level data packets, controlling formation of user data packets according to a filling degree of at least one of the buffers, and transporting the multiplexed data packets over the traffic channel.

According to another aspect of the invention, there is provided a network element of a telecommunication system, comprising a communication interface for providing a traffic channel connection between network elements and a control unit configured to create a traffic channel connection between two network elements in the telecommunication system, allocate data of a number of user entities for transportation over the traffic channel with each user having a determined, maximum channel capacity demand, the number of user entities being such that a combined maximum channel capacity demand of the user entities exceeds traffic channel data transport capacity, form data packets belonging to at least two categories, each data packet belonging to the same category being assigned with the same determined priority level, and data packets in different categories having different priority levels, buffer the data packets into separate buffers, according to the priority level of the packets, to wait for transport over the traffic channel, control multiplexing of the data packets with the determined priority levels into the traffic channel according to the priority level of the packets such that whenever higher priority level data packets are available, the higher priority level data packets are multiplexed into the traffic channel before lower priority level data packets, control formation of user data packets according to a filling degree of at least one of the buffers and control transportation of the multiplexed data packets over the traffic channel.

According to yet another aspect of the invention, there is provided a computer program product encoding a computer program of instructions for executing a computer process for transporting data in a telecommunication system. The process comprises creating a traffic channel connection between two network elements in the telecommunication system, allocating data of a number of user entities for transportation over the traffic channel with each user having a particular, maximum channel capacity demand, the number of user entities being such that a combined maximum channel capacity demand of the user entities exceeds traffic channel data transport capacity, forming data packets belonging to at least two categories, each data packet belonging to the same category being assigned with the same determined priority level, and data packets in different categories having different priority levels, buffering the data packets into separate buffers, according to the priority level of the packets, to wait for transport over the traffic channel, multiplexing the data packets with the determined priority levels into the traffic channel according to the priority level of the packets such that whenever higher priority level data packets are available, the higher priority level data packets are multiplexed into the traffic channel before lower priority level data packets, controlling formation of user data packets according to a filling degree of at least one of the buffers, and transporting the multiplexed data packets over the traffic channel.

According to yet another aspect of the invention, there is provided a computer program distribution medium readable by a computer and encoding a computer program of instructions for executing a computer process for transporting data in a telecommunication system. The process comprises creating a traffic channel connection between two network elements in the telecommunication system, allocating data of a number of user entities for transportation over the traffic channel with each user having a particular, maximum channel capacity demand, the number of user entities being such that a combined maximum channel capacity demand of the user entities exceeds traffic channel data transport capacity, forming data packets belonging to at least two categories, each data packet belonging to the same category being assigned with the same determined priority level, and data packets in different categories having different priority levels, buffering the data packets into separate buffers, according to the priority level of the packets, to wait for transport over the traffic channel, multiplexing the data packets with the determined priority levels into the traffic channel according to the priority level of the packets such that whenever higher priority level data packets are available, the higher priority level data packets are multiplexed into the traffic channel before lower priority level data packets, controlling formation of user data packets according to a filling degree of at least one of the buffers, and transporting the multiplexed data packets over the traffic channel.

An advantage the invention provides is a more efficient way to transport data between network elements in a telecommunication system by allocating both delay-sensitive and delay-tolerant data to the same virtual channel connection, and transporting delay-tolerant data whenever no delay-sensitive data is available.

### LIST OF DRAWINGS

In the following, the invention will be described in greater detail with reference to the embodiments and the accompanying drawings, in which

FIG. 1 shows an example of a structure of a telecommunication system;

FIG. 2 illustrates an example of a protocol stack related to communication between two network elements in a telecommunication system;

FIG. 3 illustrates a simplified diagram of priority scheduling of data packets into a channel;

FIG. 4 illustrates a block diagram of a preferred embodiment of a network element in a telecommunication system, and

FIG. 5 is a flow chart illustrating a method for transporting data between two network elements in a telecommunication system.

### DESCRIPTION OF EMBODIMENTS

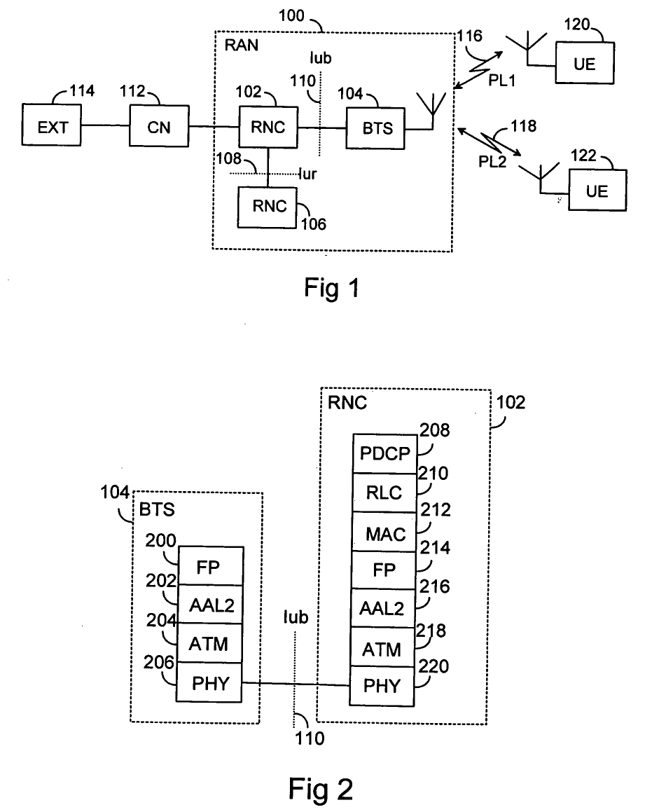

With reference to FIG. 1, examine an example of a data transmission system to which embodiments of the invention may be applied. The structure and the elements of the system illustrated in FIG. 1 are the same as in a Universal Mobile Telecommunication System (UMTS) network, and the UMTS system will be used here as a reference system wherein the proposed data transport method may be implemented. It should, however, be noted that the implementation of the proposed data transport method is not limited to the UMTS system, but it may also be implemented in other suitable telecommunication systems.

The network elements of the communication system of FIG. 1 can be grouped into a radio access network (RAN) 100, which handles all radio-related functionalities of the system, and a core network (CN) 112, which takes care of switching and routing calls and data connections to external networks 114. An external network may be for example the Internet, an Integrated Services Digital Network (ISDN), or a Public Switched Telephone Network (PSTN).

The radio access network 100 comprises one or more base transceiver stations (BTS) 104 and radio network controllers (RNC) 102, 106. A BTS 104 is responsible for providing user equipment 120, 122 with an air interface radio connection 116, 118 within its coverage area also known as a cell. The BTS 104 also performs physical level signal processing, such as modulation, channel coding, etc. The BTS 104 may also perform some basic radio resource management operations, such as operations related to power control.

A radio network controller 102 is a network element which is responsible for control of radio resources in the RAN 100. The RNC 102 serves as a switching and controlling element of the RAN 100, and typically controls several BTSs 104, but it may also control only a single BTS 104. The RNC 102 is responsible for controlling load and congestion of traffic channels of its own cells. The RNC 102 also takes care of procedures related to admission control, handovers, and power control. The radio network controller 102 typically includes a digital signal processor and software for executing computer processes stored on a computer readable medium. Furthermore, the radio network controller 102 typically includes connecting means for communicating electric signals with other network elements, such as other radio network controllers 106 and/or base transceiver stations 104, but also with the core network 112.

The core network 112 provides a combination of switching and transmission equipment, which together form a basis for telecommunication network services. The core network also performs procedures related to radio resource management. The core network 112 may provide user entities with circuit-switched and/or packet-switched data transport services.

The term ‘user entity’ is used for describing both the user equipment 120, 122 and a person using the equipment.

The interface between the RNC 102 and the BTS 104 is called an lub interface 110 in the UMTS system. Since the UMTS system is used as a reference system, the interface 110 is addressed as the lub interface. The interface between two RNCs is addressed as an lur interface 108.

Still referring to FIG. 1, the data transported to/from the first user equipment 120, using a connection 116 may have a priority level different from that of the data transported to/from the second user equipment 122, using connection 118. The first user entity 120 may be making a telephone call and is therefore transporting delay-sensitive voice as data, while the second user entity 122 may be downloading an Internet page and the transported data is delay-tolerant data. A different priority level may also depend on the user entities 120, 122, and not only on the data they transport. The first user entity 120 may be a high priority user entity and therefore all data transmitted or received by the first user entity 120 is handled in the communication network as delay-sensitive data. The user entity data may be transported over an air interface between the user entity and a serving base transceiver station, using a channel called transport channel. The transport channel may be a dedicated transport channel.

Relating to transport of user entity data over the lub interface 110 FIG. 2 illustrates transport protocol stacks of both the RNC 102 and the BTS 104. A protocol is a standard procedure and format which two data communication devices must understand, accept and use to be able to communicate with each other. The protocols needed in the BTS 104 comprise a physical layer protocol 206, an Asynchronous Transfer Mode (ATM) protocol 204, an ATM Adaptation Layer type 2 (AAL2) protocol 202 and a Frame Protocol 200.

The physical layer protocol 206 defines characteristics for encoding and decoding data into suitable electrical or optical waveforms for transmission and reception on the specific physical media used. The physical layer protocol also performs some error detection and correction.

ATM is a data transport method used for high-speed transport and switching of various types of data, voice and video signals. With ATM, the data is split into packets or cells (usually called ATM cells) having a distinct structure. With ATM data transport, a virtual channel connection (VCC) is created between transmitting and receiving entities. A VCC is a concatenation of a number of ATM links. A VCC is a unidirectional data transport channel.

The ATM protocol 204 determines where incoming data should be forwarded to, resets the corresponding connection identifiers of ATM cells and forwards the ATM cells to the next link. The ATM protocol 204 is also responsible for relaying ATM cells from the higher layer AAL2 202 to the physical layer 206 for transmission, and from the physical layer 206 to the AAL2 202 for further processing. In addition to buffering ATM cells, it also handles various traffic management functions, such as ATM cell loss priority marking and congestion indication.

The ML2 protocol 202 interfaces higher layer protocols to the ATM Layer 204, and relays data packets both from upper layers to the ATM protocol 204, and vice versa. When relaying information received from the higher layers, the AAL2 protocol 202 segments the data packets into ATM cells. When relaying information received from the ATM protocol 204, the ML2 protocol 202 must reassemble the ATM cells into a format the higher layers can understand. This is called segmentation and reassembly.

Different AALs are defined in supporting different types of traffic or service used in ATM networks. The AAL2, which is used in this example, has the advantage that is supports variable bit rate data traffic and it can multiplex data of several users into one VCC.

The Frame protocol 200 is the highest layer protocol at the BTS 104. The frame protocol 200 takes care of transfer of data packets between the RNC 102 and the physical layer of the BTS. It also transports, for example, power control and channel measurement information between the BTS 104 and the RNC 102, and also air interface parameters from the RNC 102 to the BTS 104. The Frame protocol 200 may perform some error correction on the user entity data, too.

At the RNC 102 are also provided a physical layer protocol 220, an ATM protocol 218, an AAL2 protocol 216 and a Frame Protocol 214, these protocols having the same functionalities as at the BTS 104. In addition to these, a medium access control (MAC) protocol 212, a radio link control (RLC) protocol 210, and a packet data convergence (PDCP) protocol 208 are provided as higher layer protocols on top of the frame protocol 214.

The MAC protocol 212 handles access to shared media so that the transmission path is always available during transmission. The MAC protocol receives data through a number of channels from higher layers and it maps these channels into another number of channels through which the MAC protocol 212 communicates with lower layers. For example in the UMTS, the MAC protocol 212 communicates with higher layers through logical channels and maps these channels into transport channels. The MAC protocol may also take care of selecting an appropriate transport format for each user entity depending on congestion of the virtual channel on the lub interface. Possible transport formats for a dedicated transport channel with a maximum data rate of 384 kbit/s associated with a user entity may comprise a higher data rate transport format (384 kbit/s), a lower data rate transport format (128 kbit/s) and a zero data rate transport format (0 kbit/s). The higher data rate transport format may be used if enough capacity is available in the virtual channel on the lub interface. The lower data rate transport format may be used when some congestion occurs in the virtual channel on the lub interface, and the zero data rate transport format may be used during severe congestion in the virtual channel on the lub interface. Also additional transport formats may be provided from among which the MAC protocol may choose the most suitable one for each transport channel, according to the current virtual channel status on the lub interface. Additionally, the MAC protocol 212 may perform some error correction.

The RLC protocol 210 also provides segmentation and reassembly services for both user and control data. The RLC protocol 210 segments variable-length transport blocks received from a higher layer into data packets, and vice versa. The RLC protocol 210 may also provide error correction services through retransmission of data packets. The retransmission of erroneous data packets is performed using an automatic repeat request (ARQ) mechanism. Error detection is performed on the lower layer protocols (for instance on a physical layer) and the results are delivered together with the actual data to the RLC protocol 210.

The PDCP protocol handles compression of redundant control information during transmission, and decompression during reception. Especially, when a header of a transport block comprising control information is larger than the payload comprising data, the compression results in significantly better spectral efficiency.

The physical layer protocol, the ATM protocol and the AAL2 protocol form a transport network layer of the UMTS protocol architecture, while the frame protocol and the higher layer protocols form a radio network layer of the UMTS protocol architecture. Both the transport network layer and the radio network layer may additionally comprise other functionalities.

Now that the structure of the telecommunication system and the data transport protocols of the lub interface have been described, we examine how to optimize data transport between two network elements. As an example, reference is made to the lub interface, the interface between the RNC 102 and the BTS 104, but other interfaces between network elements are also possible.

As stated above, the user entities 120, 122 may have needs to transmit or receive two kinds of data, either delay-sensitive or delay-tolerant data. Data between the user entity 120, 122 and the BTS 104 is transported over the air interface and, from thereon, using cable connections, for instance. Between the BTS 104 and the RNC 102, the user entity data is transported using an AAL2 virtual channel connection. The AAL2 VCC is also used in connection with transport of data packets between two RNCs. A feature of the AAL2 VCC is that data of several user entities may be multiplexed into one VCC. Allocation of data of the user entities 120, 122 into the VCC may be based on activity factors of the user entities 120, 122. An activity factor defines the ratio of how much of the total data transport capacity available for a user entity 120, 122 the user entity 120, 122 actually uses. As an example, in UMTS, where the maximum bit rate for data to a user entity—in a certain environment—is 384 kilobits per second, the amount of data a user entity with activity factor one would be receiving is 384 kilobits per second for the whole duration of the connection. In practice, the activity factor of a user is typically between zero and one. An operator of the telecommunication system may define an assumed activity factor per user entity, and the user allocation is performed based on that activity factor.

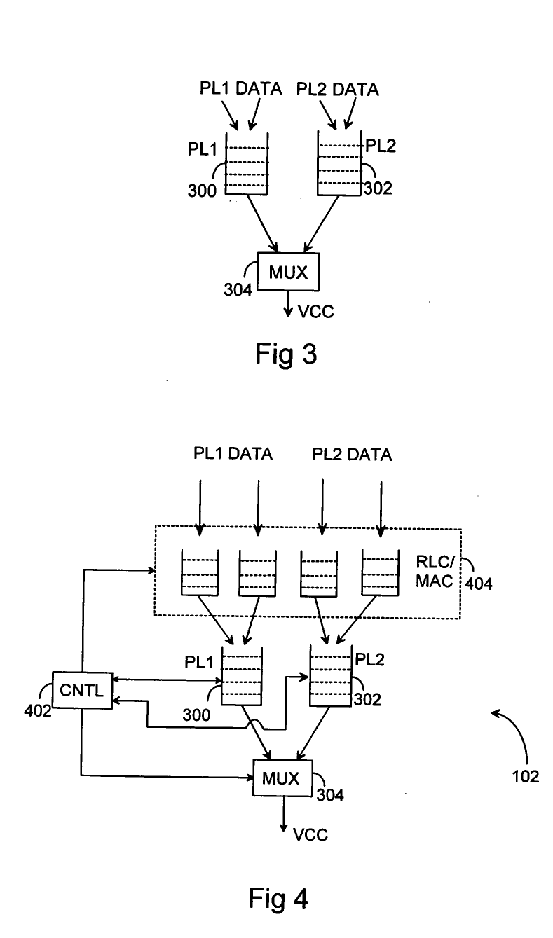

With reference to FIG. 3, an embodiment of the invention is depicted. When allocating data of the user entities 120, 122 into the VCC it is guaranteed that the VCC is provided with a sufficient amount of capacity to transport delay-sensitive data. In practice, this means that data packets carrying delay-sensitive data are transported over the VCC within a maximum delay tolerance allowed. With the delay-tolerant data, on the contrary, longer delays are allowed and thus, in order to improve utilization of the VCC, some overbooking of delay-tolerant data may be used. Overbooking means that the amount of data allocated to the channel exceeds the amount of capacity of the channel. In practice, with so many users of a VCC, it has been admitted that if every user were transporting data with the maximum bit rate available for a single user entity—i.e. each user having activity factor of one—the VCC data transport capacity would be exceeded. Overbooking, actually, corresponds to channel admission with an assumption that the activity factor of a user is less than one.

Although in reality not all users require the maximum bit rate all the time, except in special circumstances, there may still be moments at which the VCC capacity is not enough. Therefore, a portion of the data allocated to the channel has to wait for the transport of the previous data packets over the channel. The data may be stored for example in a buffer to wait to be transported over the VCC.

As in FIG. 3, two streams of data are provided, each having its own priority level (PL1 DATA and PL2 DATA). Let us assume that PL1 DATA is delay-sensitive data while PL2 DATA is delay-tolerant data. The data packets from these two streams are stored in respective buffers 300, 302 according to their priority levels. The delay-sensitive data packets are stored in the buffer 300, while the delay-tolerant data packets are stored in the buffer 302. The data packets from these buffers 300, 302 are transported over the VCC via a multiplexer 304. The multiplexer 304 transmits data packets from the buffers 300, 302 into the VCC by using priority scheduling. The priority is on the delay-sensitive data packets, which means that whenever a delay-sensitive data packet is waiting to be transported over the VCC in the buffer 300, the multiplexer 304 transmits the delay sensitive data packet into the VCC. Only when the delay-sensitive data buffer 300 is empty, are data packets from the buffer 302 containing delay-tolerant data packets are transmitted to the VCC.

Even though the example described with reference to FIG. 3 describes data packets placed in two categories with two different priority levels, the number of categories with different priority levels may be more, and the operation of overbooking and priority scheduling would be similar. A grouping may be made on the basis of which priority levels are to be used for overbooking. The priority scheduling would be similar, i.e. higher priority level data packets would be multiplexed into the VCC before lower level data packets. The number of buffers may be higher if a separate buffer is used for each priority level data packets.

Situations may occur wherein more data packets arrive at the buffers 300, 302 than are transmitted to the VCC. This may happen especially to the buffer 302 containing delay-tolerant data packets. In such a case, a need exists to limit the rate at which data packets arrive at the buffers 300, 302.

FIG. 4 presents an embodiment of the invention, and illustrates processing of data packets in an RNC 102. The multiplexer 304 and the buffers are similar to those in FIG. 3, and their operative function is also the same. Delay-sensitive and delay-tolerant data packets arrive at the buffers 300, 302, respectively, and the multiplexer 304 transmits data packets to the VCC by using priority scheduling. A controlling unit 402 controls the operation of the multiplexer 304. The controlling unit 402 may be realized with a digital signal processor with suitable software or with separate logic circuits, for example with ASIC (Application Specific Integrated Circuit).

The data packets arrive at the buffers 300, 302 from the buffers of an RLC layer via a MAC layer 404, which conveys the data packets from the RLC layer into a number of VCCs according to the particular transport format. The RLC layer buffers data for an automatic repeat request procedure. The MAC layer may also have buffers of its own, although in FIG. 4 combined data buffers are provided for both the RLC and the MAC layer 404. The controlling unit 402 controls the operation of both the RLC and MAC layer 404.

The controlling unit 402 may also monitor the filling degree of the buffers 300, 302, or the controlling unit 402 may monitor only the filling degree of the buffer 302 comprising delay-tolerant data packets. Usually, the amount of VCC capacity suffices to transport the delay-sensitive data packets, but the delay-tolerant data packets may have to wait for a longer time in the buffer 302, and thus the buffer 302 is likely to become full more often.

Two thresholds may be provided for the filling degree of the monitored buffer or buffers 300, 302. A higher threshold is to indicate that the filling degree of the buffer 300, 302 is alarmingly high, and a lower threshold is to indicate that the filling degree of the buffer 300, 302 is quite low. When the filling degree of the buffer 300, 302 exceeds the higher threshold, the controlling unit may initiate a procedure to reduce the rate at which the data packets are arriving at the buffer 300, 302. The procedure may comprise sending flow control signals to the MAC layer 404 to reduce the transmission rate of data packets or even to cease to transmit, i.e. to choose a lower data rate transport format. The MAC layer may then change the transport format of a portion of the user entities allocated to the VCC or the transport format of all the user entities allocated to the VCC. For example, the transport format of high priority user entities may be kept higher.

When the rate at which data packets arrive at a full buffer 300, 302 reduces, the filling degree of the buffer 300, 302 decreases eventually. When the filling degree of the buffer 300, 302 drops below the lower threshold, the controlling unit 402 initiates a procedure to increase the rate at which data packets arrive at the buffer 300, 302. The procedure may comprise sending flow control signals to the MAC layer 404 to increase the transmission rate of data packets, i.e. to choose a higher data rate transport format. The transmission rate may be increased gradually in order to prevent fast oscillation between congested and non-congested states of the VCC, resulting in a large amount of flow control signalling. The MAC layer may then increase the transport format of a portion of the user entities allocated to the VCC or the transport format of all the user entities allocated to the VCC.

It should also be appreciated that the flow control signalling only affects priority level data, which is contained in a buffer whose filling degree is too high. If the buffer 302 comprising delay-tolerant data packets is too full, but the filling degree of the buffer 300 comprising delay-sensitive data packets is below the higher threshold, the flow of the delay-sensitive data packets from the higher layers is not reduced. This also applies to the lower threshold, i.e. if the filling degree of the buffer 302 comprising delay-tolerant data packets drops below the lower threshold, the arrival rate of the delay-sensitive data packets is not increased.

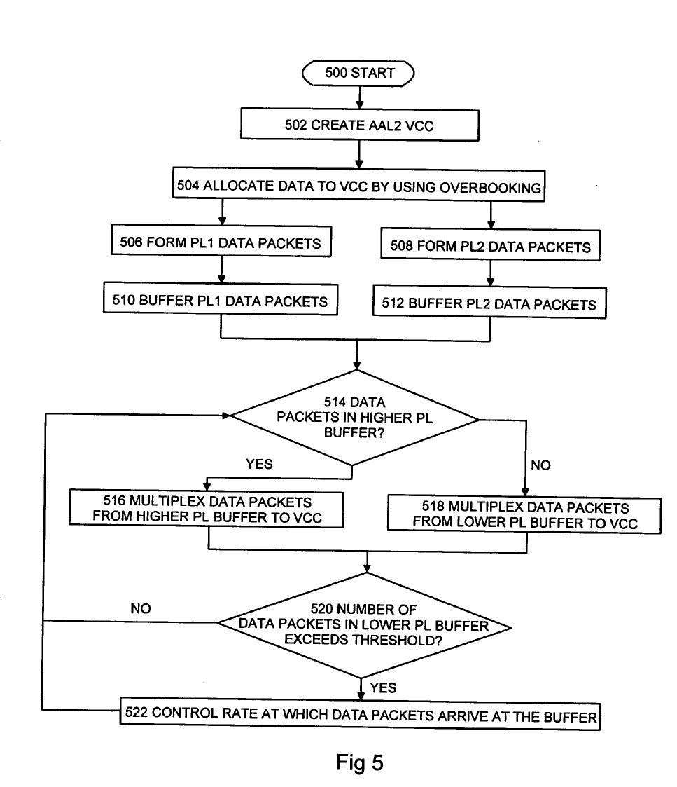

Next, a process for transporting user entity data between two network elements is depicted with reference to the flow diagram of FIG. 5.

The process starts in 500.

In 502, an AAL2 virtual channel connection between two network entities is created for each transport channel of each user entity.

In 504, data of a number of user entities is allocated to the VCC. A transport network layer or a separate admission controller may handle the allocation of data by using overbooking of user entities requiring transport of delay-tolerant data.

In 506 and 508, data packets with different priority levels—delay-sensitive and delay-tolerant data packets—are formed. This operation is carried out in an RLC layer, and the data packets are formed from the transport blocks received from higher layers.

In 510 and 512, data packets comprising delay-sensitive and delay-tolerant data are buffered into separate buffers, respectively. This operation is carried out in an AAL2 layer.

In 514 it is checked whether or not there are data packets waiting to be transported over the VCC in a higher priority level buffer, i.e. a buffer comprising delay-sensitive data packets. If there are delay-sensitive data packets, the data packets are transmitted to the VCC in 516. If no delay-sensitive data packets exist in the buffer, delay-tolerant data packets from a lower priority level, i.e. a buffer comprising delay-tolerant data packets, are transmitted to the VCC in 518.

In 520 it is checked if the number of data packets or the filling degree of the lower priority level buffer has exceeded the higher threshold value. If the filling degree has not exceeded the higher threshold value, the process returns to 514, and data packets are normally transmitted into the VCC by using priority scheduling. If the filling degree has exceeded the higher threshold value, the process moves to 522, where the rate at which data packets arrive at the buffer is controlled. The arrival rate is first either reduced or even ceased, and when the filling degree of the buffer has dropped below the lower threshold value, the rate at which data packets arrive at the buffer is gradually increased or, alternatively, instantly increased to the maximum value.

After 522 has been completed, the process returns to 514 in order to continue the transmission of data packets to the VCC by using priority scheduling.

As an embodiment, a computer program product encodes a computer program of instructions for executing a computer process of the above-described method for transporting data between network elements in a telecommunication system. The computer program product may be embodied on a computer program distribution medium. The computer program distribution medium includes all manners known in the art for distributing software, such as a computer readable medium, a program storage medium, a record medium, a computer readable memory, a computer readable software distribution package, a computer readable signal, a computer readable telecommunication signal, and a computer readable compressed software package.

Even though the descriptions have been made using an AAL2 virtual channel connection as an example, it should be appreciated that the invention is not limited thereto, and use of overbooking in conjunction with priority scheduling can also be used with other traffic channel implementations. The ATM based virtual channel in the above example may also be a logical or a physical link of a packet based network with a predetermined capacity.

Even though the invention has been described above with reference to an example according to the accompanying drawings, it is clear that the invention is not restricted thereto but it can be modified in several ways within the scope of the appended claims.

1. A data transport method in a telecommunications system, the method comprising:
creating a traffic channel connection between two network elements in the telecommunication system;
allocating data of a number of user entities for transportation over the traffic channel with each user having a particular, maximum channel capacity demand, the number of user entities being such that a combined maximum channel capacity demand of the user entities exceeds traffic channel data transport capacity;
forming data packets belonging to at least two categories, each data packet belonging to a same category being assigned with a same determined priority level, and data packets in different categories having different priority levels;
buffering the data packets into separate buffers, according to the priority level of the packets, to wait for transport over the traffic channel;
multiplexing the data packets with the determined priority levels into the traffic channel according to the priority level of the packets such that whenever higher priority level data packets are available, the higher priority level data packets are multiplexed into the traffic channel before lower priority level data packets;
controlling formation of user data packets according to a filling degree of at least one of the buffers; and
transporting the multiplexed data packets over the traffic channel.

2. The method of claim 1, wherein the traffic channel connection is an asynchronous transfer mode adaptation layer type 2 virtual channel connection.

3. The method of claim 1, wherein at least one category comprises delay-sensitive data packets and at least one other category comprises delay-tolerant data packets.

4. The method of claim 1, wherein controlling the formation of user packets is implemented by using different transport formats, depending on the filling degree of at least one of the buffers.

5. The method of claim 1, wherein all data associated with a at least one user entity is delay-sensitive data.

6. The method of claim 5, wherein:
allocating data of user entities for transportation over the traffic channel is carried out by a transport network layer;
forming of user entity data packets is carried out by a radio link control protocol;
buffering the data packets into separate buffers, according to the priority level of the packets, to wait to be transported over the traffic channel, is carried out by an asynchronous transfer mode adaptation layer type 2 protocol;
multiplexing of the data packets with the determined priority levels into the traffic channel is carried out by the asynchronous transfer mode adaptation layer type 2 protocol; and
controlling the formation of user data packets according to the filling degree of at least one of the buffers is carried out by using control signalling from the asynchronous transfer mode adaptation layer type 2 protocol to a medium access control protocol and the radio link control protocol.

7. A network element of a telecommunication system, comprising:
a communication interface for providing a traffic channel connection between network elements; and
a control unit configured to create a traffic channel connection between two network elements in the telecommunication system,
the control unit is also configured to allocate data of a number of user entities for transportation over the traffic channel with each user having a determined, maximum channel capacity demand, the number of user entities being such that a combined maximum channel capacity demand of the user entities exceeds traffic channel data transport capacity,
the control unit is further configured to form data packets belonging to at least two categories, each data packet belonging to the same category being assigned with the same determined priority level, and data packets in different categories having different priority levels,
the control unit is also configured to buffer the data packets into separate buffers, according to the priority level of the packets, to wait for transport over the traffic channel,
the control unit is further configured to control multiplexing of the data packets with the determined priority levels into the traffic channel according to the priority level of the packets such that whenever higher priority level data packets are available, the higher priority level data packets are multiplexed into the traffic channel before lower priority level data packets,
the control unit is also configured to control formation of user data packets according to a filling degree of at least one of the buffers and to control transportation of the multiplexed data packets over the traffic channel.

8. The network element of claim 7, wherein the traffic channel connection is an asynchronous transfer mode adaptation layer type 2 virtual channel connection.

9. The network element of claim 7, wherein at least one category comprises delay-sensitive data packets, and at least one other category comprises delay-tolerant data packets.

10. The network element of claim 7, wherein the control unit is further configured to use different transport formats, depending on the filling degree of at least one of the buffers.

11. A network element comprising:
communication means for providing a traffic channel connection between network elements;
means for creating a traffic channel connection between two network elements in a telecommunications system;
means for allocating data of a number of user entities for transportation over the traffic channel with each user having a determined, maximum channel capacity demand, the number of user entities being such that a combined maximum channel capacity demand of the user entities exceeds traffic channel data transport capacity;
means for forming user entity data packets belonging to at least two categories, each data packet belonging to the same category being assigned with the same determined priority level, and data packets in different categories having different priority levels;
means for buffering the data packets into separate buffers, according to the priority level of the packets, to wait for transport over the traffic channel;
means for controlling multiplexing of the data packets with the determined priority levels into the traffic channel according to the priority level of the packets such that whenever higher priority level data packets are available, the higher priority level data packets are multiplexed into the traffic channel before lower priority level data packets;
means for controlling formation of user data packets according to a filling degree of at least one of the buffers and
means for controlling transportation of the multiplexed data packets over the traffic channel.

12. A computer program product embodied on a computer readable medium, the computer program product encoding instructions for executing a computer process for transporting data in a telecommunication system, the computer process comprising:
creating a traffic channel connection between two network elements in the telecommunication system;
allocating data of a number of user entities for transportation over the traffic channel with each user having a particular, maximum channel capacity demand, the number of user entities being such that a combined maximum channel capacity demand of the user entities exceeds traffic channel data transport capacity;
forming data packets belonging to at least two categories, each data packet belonging to the same category being assigned with the same determined priority level, and data packets in different categories having different priority levels;
buffering the data packets into separate buffers, according to the priority level of the packets, to wait for transport over the traffic channel;
multiplexing the data packets with the determined priority levels into the traffic channel according to the priority level of the packets such that whenever higher priority level data packets are available, the higher priority level data packets are multiplexed into the traffic channel before lower priority level data packets;
controlling formation of user data packets according to a filling degree of at least one of the buffers; and
transporting the multiplexed data packets over the traffic channel.

13. A computer program distribution medium readable by a computer and encoding a computer program of instructions for executing a computer process for transporting data in a telecommunication system, the process comprising:
creating a traffic channel connection between two network elements in the telecommunication system;
allocating data of a number of user entities for transportation over the traffic channel with each user having a particular, maximum channel capacity demand, the number of user entities being such that a combined maximum channel capacity demand of the user entities exceeds traffic channel data transport capacity;
forming data packets belonging to at least two categories, each data packet belonging to the same category being assigned with the same determined priority level, and data packets in different categories having different priority levels;
buffering the data packets into separate buffers, according to the priority level of the packets, to wait for transport over the traffic channel;
multiplexing the data packets with the determined priority levels into the traffic channel according to the priority level of the packets such that whenever higher priority level data packets are available, the higher priority level data packets are multiplexed into the traffic channel before lower priority level data packets;
controlling formation of user data packets according to a filling degree of at least one of the buffers; and
transporting the multiplexed data packets over the traffic channel.

14. The computer program distribution medium of claim 13, comprising at least one of a computer readable medium, a program storage medium, a record medium, a computer readable memory, a computer readable software distribution package, a computer readable signal, a computer readable telecommunications signal, and a computer readable compressed software package.
